(19) United States
(12) Patent Application Publication
(10) Pub. No.: US 2019/0213513 A1
(43) Pub. Date: Jul. 11, 2019

(54) RIDE SHARING OPTIONS FOR GROUPS

(71) Applicant: International Business Machines Corporation, Armonk, NY (US)

(72) Inventors: Lisa Seacat DeLuca, Baltimore, MD (US); Steve McDuff, Markham (CA)

(21) Appl. No.: 15/863,407

(22) Filed: Jan. 5, 2018

(51) Int. Cl. G06Q 10/06; G06Q 20/38

(52) U.S. Cl. CPC G06Q 10/06311; G06Q 20/38

(57) ABSTRACT

Providing ride sharing options for a group can estimating, using a processor of a requesting device, a number of a plurality of passengers to share a ride from a ride sharing service by detecting proximate devices and determining, using the processor, ride preferences for at least one of the plurality of passengers. Providing ride sharing options can include determining, using the processor, a ride sharing option from the ride sharing service for the ride based upon the number of the plurality of passengers and the ride preferences and initiating, using the processor, the ride sharing option.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

This disclosure relates to ride sharing services. Ride sharing services are growing in popularity. A ride sharing service refers to a network computing system in which users, using devices such as mobile phones, are able to request rides from available and/or nearby vehicles participating in the ride sharing service. When requesting a ride, a user typically specifies a starting location where the user is to be picked up and destination where the user is to be dropped off. In some cases, ride sharing services provide different vehicle options for accommodating different numbers of passengers. As such, when requesting a ride, users may also specify the type of vehicle that is desired for the ride.

### SUMMARY

In one or more embodiments, a method includes estimating, using a processor of a requesting device, a number of a plurality of passengers to share a ride from a ride sharing service by detecting proximate devices and determining, using the processor, ride preferences for at least one of the plurality of passengers. The method can include determining, using the processor, a ride sharing option from the ride sharing service for the ride based upon the number of the plurality of passengers and the ride preferences and requesting, using the processor, the ride sharing option.

In one or more embodiments, a system includes a memory configured to store program code and a processor coupled to the memory. The processor, in response to executing the program code, is configured to initiate operations. The operations can include estimating a number of a plurality of passengers to share a ride from a ride sharing service by detecting proximate devices and determining ride preferences for at least one of the plurality of passengers. The operations can also include determining a ride sharing option from the ride sharing service for the ride based upon the number of the plurality of passengers and the ride preferences and requesting the ride sharing option.

In one or more embodiments, a computer program product includes a computer readable storage medium having program instructions embodied therewith. The program instructions are executable by a processor of a requesting device to cause the processor to initiate operations. The operations can include estimating, using a processor of a requesting device, a number of a plurality of passengers to share a ride from a ride sharing service by detecting proximate devices and determining, using the processor, ride preferences for at least one of the plurality of passengers. The operations can also include determining, using the processor, a ride sharing option from the ride sharing service for the ride based upon the number of the plurality of passengers and the ride preferences and requesting, using the processor, the ride sharing option.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 depicts an example of a network computing system for use with one or more embodiments described within this disclosure.

FIG. 2 depicts an example architecture for a device for use with one or more embodiments described within this disclosure.

FIG. 3 depicts an example method of providing ride sharing options for groups.

FIG. 4 depicts an example of a user interface for use with one or more embodiments described within this disclosure.

FIG. 5 depicts another example of user interface for use with one or more embodiments described within this disclosure.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to ride sharing services and, more particularly, to determining ride sharing options for groups of passengers. In accordance with the inventive arrangements disclosed herein, a system and/or device is capable of automatically determining one or more ride sharing options for a ride from a ride sharing service. The system is capable of determining the ride sharing options based, at least in part, upon a number of passengers in a group that are to share a ride to a common destination. The system is also capable of taking into account various passenger preferences for the ride. The system is capable of presenting one or more of the ride sharing options to a user, e.g., one of the passengers and/or suggesting a ride sharing option based upon the passenger preferences and the number of passengers for the ride.

Based upon a selection of a ride sharing option, the system is capable of requesting the ride sharing option. For example, the system is capable of performing operations such as requesting one or more vehicles in fulfillment of the selected ride sharing option, providing instructions to the vehicle(s) selected in fulfillment of the ride sharing option, and providing payment to the vehicle(s) (e.g., the drivers) in fulfillment of the ride sharing option. The system is capable of providing payment from a single account or from a plurality of different accounts.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

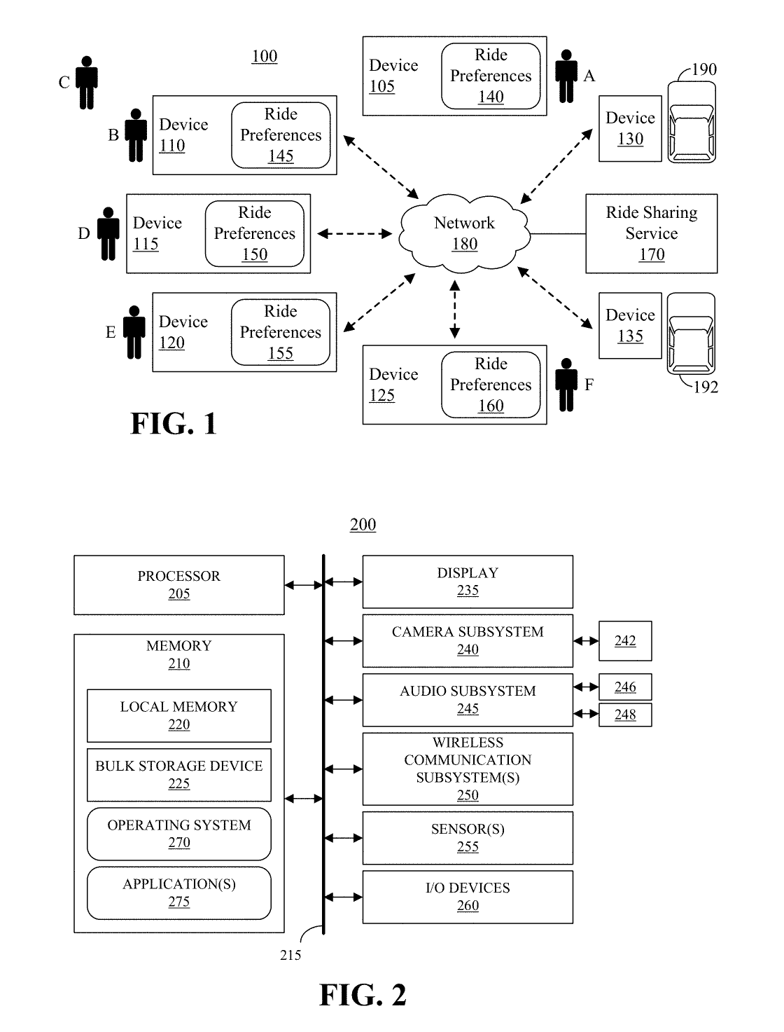

FIG. 1 depicts an example of a network computing system 100 for use with one or more embodiments described within this disclosure. Network computing system 100 contains a plurality of devices capable of communicating with one another. In the example of FIG. 1, network computing system 100 includes devices 105, 110, 115, 120, 125, 130, and 135. Further, network computing system 100 includes a ride sharing service 170 and a network 180. For purposes of illustration, devices 105-125 are devices of users that are passengers or potential passengers. Devices 130 and 135 are devices of drivers of vehicles registered with ride sharing service 170.

In one or more embodiments, devices 105-135 and ride sharing service 170 are interconnected, e.g., communicatively linked, by network 180. Network 180 is the medium used to provide communication links between various devices and service (e.g., data processing systems) connected together within network computing system 100. Network 180 may include connections, such as wired communication links, wireless communication links, or fiber optic cables. Network 180 may be implemented as, or include, one or more or any combination of different communication technologies such as a Wide Area Network (WAN), a Local Area Network (LAN), a wireless network (e.g., a wireless WAN and/or a wireless LAN), a mobile or cellular network, a Virtual Private Network (VPN), the Internet, the Public Switched Telephone Network (PSTN), and so forth.

Devices 105-135 are capable of coupling to network 180 via wired and/or wireless communication links. Devices 105-135 may be implemented as personal computers, portable computing or communication devices, network computers, tablet computers, mobile phones, or other suitable devices. Further, one or more of devices 105-135 may be implemented as one type of device, while one or more others of devices 105-135 may be implemented as another different type of device, while still others of devices 105-135 may be is implemented as yet another different type of device.

In one or more other embodiments, one or more of devices 105-135 are capable of communicating with one another via peer-to-peer communication links. Peer-to-peer communication links may include ad-hoc communication links where devices are capable of communicating directly with one another without an intervening computing node or system. Examples of peer-to-peer communication links include, Bluetooth® communication links and near field communication (NFC) links.

Ride sharing service 170 is capable of coupling to network 180 via wired and/or wireless communication links. Ride sharing service 170 may be implemented as one or more interconnected computer systems, e.g., servers. Ride sharing service 170 is capable of executing suitable operational software to support the various operations described herein. Ride sharing service 170 is capable of relaying messages, e.g., data and/or other instructions, among devices 105-135. Ride sharing service 170, for example, is capable of communicating with each of devices 105-135 through a client application executing within each respective one of devices 105-135.

For purposes of illustration, consider an example where users A, B, C, D, E, and F are located proximate to one another. The term “proximate”, as used herein, means that one entity is within a predetermined distance of another entity. For example, users A, B, C, D, E, and F may be colleagues standing in a group talking to one another or walking out of a building together as a group. In this example, users A, B, C, D, and E are planning on going to a common destination together, e.g., a restaurant for lunch, as a group. User F does not intend on joining the group for lunch. As illustrated, users A, B, D, E, and F have devices 105, 110, 115, 120, and 125, respectively. Each of devices 105-125 is capable of executing a ride sharing application (not shown). Further, devices 105-125 are capable of storing ride preferences 140, 145, 150, 155, and 160, respectively.

In the example of FIG. 1, users A, B, C, D, and E have decided to use ride sharing service 170 to book a ride to their common destination. As used herein, the term “ride” refers to a journey characterized by a starting location and a destination. User A may execute, or launch, the ride sharing application on passenger device 105. Further, user A may initiate a process on device 105 for obtaining ride sharing options for the group.

In one or more embodiments, passenger device 105 is capable of estimating the number of passengers in the group for the ride. In particular embodiments, passenger device 105 is capable of using one or more different proximity-based technologies to detect other devices in proximity to passenger device 105. In one example, passenger device 105 is capable of detecting other proximate devices using device discovery and/or device polling mechanisms as may be available within communication protocols and/or technologies such as Bluetooth®, near field communication, WiFi® (e.g., any of the 802.xx family of communication protocols), or other suitable communication technologies. In particular embodiments, devices 110-125 are capable of sharing location information. For example, each respective one of passenger devices 110-125 is capable of determining Global Positioning System (GPS) coordinates and sharing, via the ride sharing application executing in each respective device, such information with device 105.

Within this disclosure, various types of information may be shared among devices. In accordance with one or more embodiments described herein, users of devices are able to “opt in” to sharing such information. For example, users can configure their respective devices by granting permission for the ride sharing application to access and/or share information that may be used in arranging and/or requesting a ride sharing option for a group with other devices. Examples of information for which users may grant permission to share include, but are not limited to, ride preferences, particular items of ride preferences, location information, and/or calendar information.

In the example of FIG. 1, passenger device 105 is capable of determining the number of passengers in the group based upon the number of detected proximate devices. In one or more embodiments, passenger device 105 may estimate the number of passengers in the group to be five having detected, including passenger device 105 itself, passenger devices 110, 115, 120, and 125.

In one or more other embodiments, ride sharing preferences within each respective passenger device may indicate additional information that may influence the estimated number of passengers determined by passenger device 105. For example, user C does not have a device that is detected by passenger device 105. User C, for example, may be a spouse, a child, or a colleague of user B. Accordingly, ride preferences 145 within passenger device 110 may indicate that when passenger device 110 is polled, passenger device 110 response with a count of two passengers (e.g., a count that reflects user B and any other additional users accompanying user B) instead of a count of one. User B for example may set ride preferences 145 to specify a number of passengers other than one to accommodate for situations where user B is accompanied by one or more other persons that should be counted in the group for a ride but that do not have devices or do not have the ride sharing application. In this example, passenger device 105 would estimate six passengers in the group (e.g., users A, B, C, D, E, and F).

In one or more other embodiments, passenger device 105 is capable of obtaining information from devices 110-125 that enables device 105 to exclude one or more devices from being counted in the estimated number of passengers in the group. In this example, as noted, user F does not intend to join the group for lunch. In one aspect, user F may activate an “opt out” option so as not to be counted by device 105. In another aspect, passenger device 125 may include calendar information specifying a meeting that is scheduled for a time that conflicts with the ride being scheduled. For example, the meeting may be scheduled to occur within the next 5, 10, 15, 20, 25, or 30 minutes. In this case, passenger device 105 is capable of requesting and/or receiving calendar data from devices 110-125. In response to receiving calendar data from device 125, device 105 is capable of detecting the meeting that conflicts with the ride (e.g., a meeting scheduled to occur within a predetermined amount of time of the current time). In response, device 105 is capable of excluding device 125 from being included in the estimated number of passengers in the group. As such, in this example passenger device 105 estimates the number of passengers to be 5 (e.g., including users A, B, C, D, and E).

Passenger device 105 may provide a notification indicating the estimated number of passengers and provide user A with an opportunity to update or correct the estimated number of passengers.

In addition, passenger device 105 is capable of determining one or more different ride sharing options available for the ride from ride sharing service 170. The ride sharing options may provide the group with different alternatives and/or choices relating to the number of vehicles used for the ride, the size and/or sizes of vehicle(s) used for the ride (e.g., where different sized vehicles have different passenger capacities), different types of vehicle(s) available for the ride, cost, and different expected arrival times of the vehicle(s) at the destination.

In particular embodiments, passenger device 105 is capable of determining ride sharing options based upon ride preferences 140, 145, 150, and/or 155. Ride preferences may specify, on a per user basis, preferences for particular sized vehicles, particular types of vehicles, a number of accompanying users, whether a user must travel with one or more other users, whether other counted passengers or accompanying users such as user C, in the same vehicle, age of the user and/or accompanying users, and whether the user or accompanying users require any special accommodations.

For purposes of illustration, an example of a special accommodation may be wheelchair access. An example where users may wish to ride in the same vehicle where multiple vehicles may be required include a child riding in the same vehicle as the parent or two or more colleagues having a preference to ride in a same vehicle. In the example of FIG. 1, ride preferences 145, for example, may specify that user B is to travel in the same car as user C. Further ride preferences 145 may specify an age of user C. Device 105 is capable of determining whether a booster seat or a car seat is necessary based upon the specified age of user C from ride preferences 145 obtained from device 110.

Passenger device 105 is capable of determining one or more ride sharing options based upon the number of passengers in the group that are to share the ride, the ride preferences of passenger(s) in the group, the destination, and/or available vehicles registered with ride sharing service 170. User A may select a ride sharing option. In response to user A selecting the ride sharing option, passenger device 105 requests the ride sharing option, which may include more than one vehicle to be used for the ride. In the example of FIG. 1, the ride sharing option includes two vehicles. Device 130 corresponds to a first vehicle 190 and device 135 corresponds to the second vehicle 192.

In the example of FIG. 1, passenger device 105 is capable of providing instructions to each of vehicles 190 and 192 by providing the instructions to device 130 and device 135, respectively. For example, device 105 is capable of providing the same pickup location and destination instructions to each of devices 130 and 135. In another example, device 105 is capable of providing the same pickup location to each of devices 130 and 135 and providing the destination to device 130, while instructing device 135 to follow vehicle 190.

Passenger device 105 is further capable of providing payment for the selected ride sharing option using one or more selected ride sharing accounts. In one or more embodiments, the particular ride sharing account or accounts used for providing payment may be specified within ride preferences 140 of device 105. As an illustrative and nonlimiting example, passenger device 105 may provide payment to the account associated with device 130 and to the account associated with device 135 from the account associated with the user A, from another selected account such as a business account to which user A has access, or from two or more other accounts that may correspond to user A and/or one or more other passengers in the group. As such, passenger device 105 is capable of initiating a ride for a group with flexible vehicle options and flexible payment options. In other conventional systems, requesting more than one vehicle for a group would require that the group first decide how many vehicles to request and that, for each vehicle, a different user needs to request that vehicle. Each different user requesting a vehicle would provide independent instructions to the vehicle as to pickup location and destination and also pay individually for the vehicle. As such, in conventional systems, the ability to pay for multiple vehicles from a single account or to pay from different combinations of accounts is foreclosed.

FIG. 1 is provided for purposes of illustration and is not intended to limit the inventive arrangements described herein. It should be appreciated that network computing system 100 may include fewer elements than shown or more elements than shown. For example, network computing system 100 may include fewer or more servers, devices (whether for passengers or for drivers), and/or other systems (e.g., an online calendar system for obtaining calendar data for potential passengers).

FIG. 2 illustrates an example architecture 200 for device 105 for use with one or more embodiments described within this disclosure. Devices 110-135 also may be implemented the same as, or similar to, the example architecture 200 of FIG. 2. Architecture 200 includes at least one processor 205. Processor 205 is coupled to memory 210 through interface circuitry 215. Architecture 200 stores computer readable instructions (also referred to as “program code”) within memory 210. Memory 210 is an example of computer readable storage media. Processor 205 executes the program code accessed from memory 210 via interface circuitry 215.

Memory 210 includes one or more physical memory devices such as, for example, a local memory 220 and a bulk storage device 225. Local memory 220 is implemented as one or more non-persistent memory devices used during actual execution of the program code. Examples of local memory 220 include random access memory (RAM) and/or any of the various types of RAM (e.g., static RAM, dynamic RAM) that are suitable for use by a processor during execution of program code. Bulk storage device 225 is implemented as one or more persistent data storage devices. Examples of bulk storage device 225 include a hard disk drive (HDD), a solid-state drive (SSD), flash memory, a read-only memory (ROM), an erasable programmable read-only memory (EPROM), electrically erasable programmable read-only memory (EEPROM), or other suitable memory. Architecture 200 may also include one or more cache memories (not shown) that provide temporary storage of at least some program code in order to reduce the number of times program code must be retrieved from a bulk storage device during execution.

Examples of interface circuitry 215 include, but are not limited to, an input/output (I/O) subsystem, an I/O interface, a bus system, and a memory interface. For example, interface circuitry 115 may be implemented as any of a variety of bus structures and/or combinations of bus structures including a memory bus or memory controller, a peripheral bus, an accelerated graphics port, and a processor or local bus.

In one or more embodiments, processor 205, memory 210, and/or interface circuitry 215 are implemented as separate components. In one or more embodiments, processor 205, memory 210, and/or interface circuitry 215 are integrated in one or more integrated circuits. The various components in architecture 200, for example, can be coupled by one or more communication buses or signal lines (e.g., interconnects and/or wires). In particular embodiments, memory 210 is coupled to interface circuitry 215 via a memory interface, e.g., a memory controller (not shown).

Architecture 200 may include a display 235. In particular embodiments, display 235 is implemented as touch-sensitive or touchscreen display capable of receiving touch input from a user. A touch sensitive display and/or a touch-sensitive pad is capable of detecting contact, movement, gestures, and breaks in contact using any of a variety of available touch sensitivity technologies. Example touch sensitive technologies include, but are not limited to, capacitive, resistive, infrared, and surface acoustic wave technologies, and other proximity sensor arrays or other elements for determining one or more points of contact with a touch sensitive display and/or device.

Architecture 200 may include a camera subsystem 240. Camera subsystem 240 can be coupled to interface circuitry 215 directly or through a suitable input/output (I/O) controller. Camera subsystem 240 can be coupled to an optical sensor 242. Optical sensor 242 may be implemented using any of a variety of technologies. Examples of optical sensor 242 can include, but are not limited to, a charged coupled device (CCD) or a complementary metal-oxide semiconductor (CMOS) optical sensor. Camera subsystem 240 and optical sensor 242 are capable of performing camera functions such as recording images and/or recording video.

Architecture 200 may include an audio subsystem 245. Audio subsystem 245 can be coupled to interface circuitry 215 directly or through a suitable input/output (I/O) controller. Audio subsystem 245 can be coupled to a speaker 246 and a microphone 248 to facilitate voice-enabled functions, such as voice recognition, voice replication, digital recording, and telephony functions.

Architecture 200 may include one or more wireless communication subsystems 250. Each of wireless communication subsystem(s) 250 can be coupled to interface circuitry 215 directly or through a suitable I/O controller (not shown). Each of wireless communication subsystem(s) 250 is capable of facilitating communication functions. Examples of wireless communication subsystems 250 can include, but are not limited to, radio frequency receivers and transmitters, and optical (e.g., infrared) receivers and transmitters. The specific design and implementation of wireless communication subsystem 250 can depend on the particular type of architecture 200 implemented and/or the communication network(s) over which architecture 200 is intended to operate.

As illustrative and non-limiting examples, wireless communication subsystem(s) 250 may be designed to operate over one or more mobile networks (e.g., GSM, GPRS, EDGE), a WiFi network which may include a WiMax network, a short-range wireless network (e.g., a Bluetooth® network), NFC, and/or any combination of the foregoing. Wireless communication subsystem(s) 150 can implement hosting protocols such that architecture 200 can be configured as a base station for other wireless devices.

Architecture 200 may include one or more sensors 255. Each of sensors 255 can be coupled to interface circuitry 215 directly or through a suitable I/O controller (not shown). Examples of sensors 255 that can be included in architecture 200 include, but are not limited to, a motion sensor, a light sensor, and a proximity sensor to facilitate orientation, lighting, and proximity functions, respectively, of a device using architecture 200. Other examples of sensors 255 can include, but are not limited to, a location sensor (e.g., a GPS receiver and/or processor) capable of providing geo-positioning sensor data, an electronic magnetometer (e.g., an integrated circuit chip) capable of providing sensor data that can be used to determine the direction of magnetic North for purposes of directional navigation, an accelerometer capable of providing data indicating change of speed and direction of movement of a device using architecture 200 in 3-dimensions, and an altimeter (e.g., an integrated circuit) capable of providing data indicating altitude.

Architecture 200 further may include one or more input/output (I/O) devices 260 coupled to interface circuitry 215. I/O devices 260 may be coupled to architecture 200, e.g., interface circuitry 215, either directly or through intervening I/O controllers (not shown). Examples of I/O devices 260 include, but are not limited to, a track pad, a keyboard, a display device, a pointing device, one or more communication ports (e.g., Universal Serial Bus (USB) ports), a network adapter, and buttons or other physical controls. A network adapter refers to circuitry that enables architecture 200 to become coupled to other systems, computer systems, remote printers, and/or remote storage devices through intervening private or public networks. Modems, cable modems, Ethernet interfaces, and wireless transceivers not part of wireless communication subsystem(s) 250 are examples of different types of network adapters that may be used with architecture 200. One or more of I/O devices 260 may be adapted to control functions of one or more or all of sensors 255 and/or one or more of wireless communication subsystem(s) 250.

Memory 210 stores program code. Examples of program code include, but are not limited to, routines, programs, objects, components, logic, and other data structures. For purposes of illustration, memory 210 stores an operating system 270 and application(s) 275. Applications 275 can include, for example, a ride sharing application. In one or more embodiments, the ride sharing application, when executed, is capable of causing a device using architecture 200 and/or other devices that may be communicatively linked with the device using architecture 200, to perform the various operations described herein. Memory 210 is also capable of storing data, whether data utilized by operating system 270, data utilized by application(s) 275, data received from user inputs, data generated by one or more or all of sensor(s) 255, data received and/or generated by camera subsystem 240, data received and/or generated by audio subsystem 245, and/or data received by I/O devices 260.

In an aspect, operating system 270 and application(s) 275, being implemented in the form of executable program code, are executed by architecture 200 and, more particularly, by processor 205, to perform the operations described within this disclosure. As such, operating system 270 and application(s) 275 may be considered an integrated part of architecture 200. Further, it should be appreciated that any data and/or program code used, generated, and/or operated upon by architecture 200 (e.g., processor 205) are functional data structures that impart functionality when employed as part of architecture 200.

Memory 210 is also capable of storing additional program code. Examples of additional program code include, but are not limited to, instructions that facilitate communicating with one or more additional devices, one or more computers and/or one or more servers; graphic user interface (GUI) and/or UI processing; sensor-related processing and functions; phone-related processes and functions; electronic-messaging related processes and functions; Web browsing-related processes and functions; media processing-related processes and functions; GPS and navigation-related processes and functions; security functions; and camera-related processes and functions including Web camera and/or Web video functions.

Architecture 200 further can include a power source (not shown). The power source is capable of providing electrical power to the various elements of architecture 200. In an embodiment, the power source is implemented as one or more batteries. The batteries may be implemented using any of a variety of known battery technologies whether disposable (e.g., replaceable) or rechargeable. In another embodiment, the power source is configured to obtain electrical power from an external source and provide electrical power (e.g., direct current (DC) power) to the elements of device. In the case of a rechargeable battery, the power source further may include circuitry that is capable of charging the battery or batteries when coupled to an external power source.

Architecture 200 is provided for purposes of illustration and not limitation. A device and/or system configured to perform the operations described herein may differ from architecture 200 illustrated in FIG. 2. Such other architecture may be a simplified version of architecture 200 described in connection with FIG. 2 that includes a memory capable of storing instructions and a processor capable of executing instructions. In this regard, architecture 200 may include fewer components than shown or additional components not illustrated in FIG. 2 depending upon the particular type of device that is implemented. In addition, the particular operating system and/or application(s) included may vary according to device type as may the types of I/O devices 260 included. Further, one or more of the illustrative components may be incorporated into, or otherwise form a portion of, another component. For example, a processor may include at least some memory.

Architecture 200 may be used to implement a data processing system, a communication device, or other suitable system that is suitable for storing and/or executing program code. Examples of devices that may be implemented using architecture 200 include, but are not to limited to, a smart phone or other mobile device or phone, a wearable computing device (e.g., a smart watch), a computer (e.g., desktop, laptop, or tablet computer), and/or other suitable communication device.

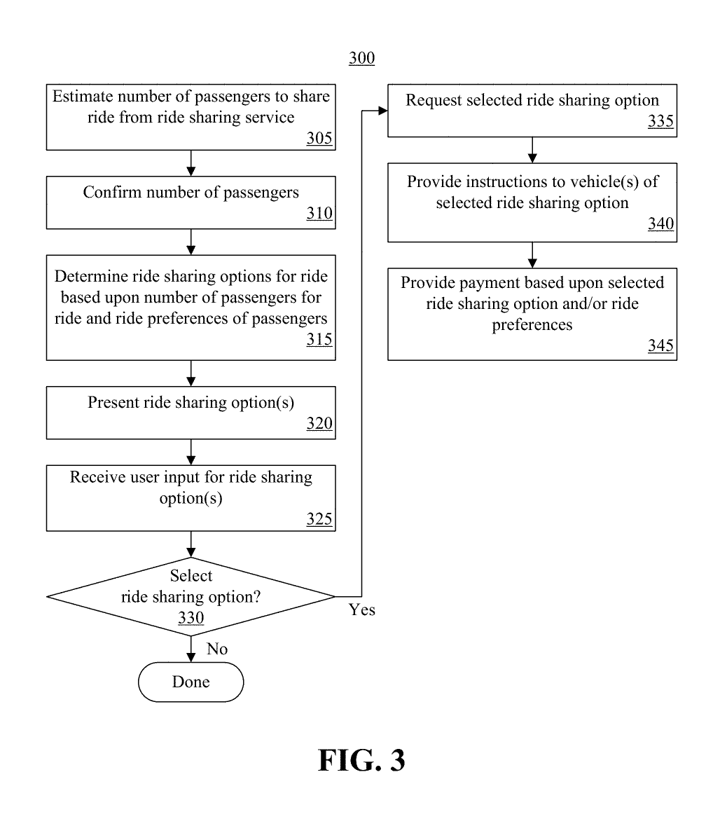

FIG. 3 depicts an example method 300 of providing ride sharing options for groups. Method 300 may be performed by a device as described herein in connection with FIGS. 1 and 2. In the example of FIG. 3, a group of two or more users are proximate to one another and have decided to use a ride sharing service to book a ride to a common destination. One of the users executes or launches a ride sharing application executing in the user's device (referred to as the “requesting device”) and initiates a process for obtaining ride sharing options for the group. In one or more embodiments, in initiating the process, the user specifies the pickup location and the destination for the ride.

In block 305, the requesting device optionally estimates the number of passengers in the group that are to share the ride from the ride sharing service. In one or more embodiments, the requesting device estimates the number of passengers automatically based upon detecting other devices that are proximate to the requesting device. In particular embodiments, the requesting device is capable of checking calendar information from one or more or all of the other devices and excluding one or more of the detected devices based upon determining that such detected devices have a scheduled meeting listed in the calendar information that conflicts with the ride currently being arranged.

In one or more other embodiments, the requesting device is capable of obtaining ride preferences from the other devices. For example, as part of the polling and/or device discovery process, the requesting device is capable of requesting and obtaining ride preferences from the other devices. Accordingly, in particular embodiments, the requesting device is capable of estimating the number of passengers also based upon ride preferences that may be received from one or more or all of the detected devices. Ride preferences for a given device may indicate that the user that owns the device typically travels with one or more other persons (e.g., accompanying users) such as a spouse or one or more children. In that case, detected devices polled by the requesting device may respond with a number of passengers for that device that includes the user of the device plus any other accompanying users. Accordingly, the requesting device is capable of estimating the number of passengers in the group based upon the responses received from each of the detected devices and/or whether or not a device may be automatically excluded from inclusion the group based upon a detected conflict.

In block 310, the requesting device optionally confirms the number of passengers. For example, the requesting device may display a user interface or provide an audio prompt indicating the number of passengers estimated in the group. The user of the requesting device, in response to the confirmation notification, is capable of accepting the estimated number or providing an updated number of passengers in the group as an input to the requesting device.

In one or more other embodiments, the user of the requesting device may directly enter the number of passengers within the group into the requesting device. In such embodiments, the requesting device need not perform any polling or other detection of proximate devices.

In block 315, the requesting device determines one or more ride sharing options for the ride based upon the number of passengers for the ride and the ride preferences of the passengers. The requesting device is further capable of determining ride sharing options based upon the vehicles registered with the ride sharing service that are available for the ride.

In one or more embodiments, the requesting device is capable of determining ride sharing options based upon ride preferences stored within the requesting device. The ride preferences may indicate the type of ride sharing options that are most desirable for the user of the requesting device. For example, the ride sharing options may indicate user preferences such preferences for the least expensive ride sharing option, ride sharing options with earlier estimated arrival times (e.g., with respect to the destination), available ride sharing options based upon a specified minimum number of vehicles to be used for the ride, or ride sharing options that include a particular type of vehicle (e.g., luxury or “premium” vehicles, sport utility vehicles, or other suitable preference).

In one or more embodiments, the requesting device is capable of determining ride sharing options based upon ride preferences for one or more of the other passengers of the group. Other passengers of the group may have ride preferences for a particular size and/or type of vehicle, for vehicles that can accommodate or have a child safety seat of a particular type (car seat or booster seat), or other preference. In particular embodiments, the ride preferences of a passenger may indicate a “same vehicle preference” indicating that one or more other passengers of the group (e.g., a subset of passengers of the group) are to travel within the same vehicle.

The requesting device determines available ride sharing options from the ride service. In doing so, the requesting device is capable of accounting for any price surges that may be in effect. Each ride sharing option may use different combinations of vehicles and/or vehicle types.

As an illustrative and non-limiting example, the requesting device may determine a first ride sharing option that uses two large vehicles for a price of $14.00-$18.00. The requesting device may determine a second ride sharing option that uses one extra-large vehicle and one large vehicle for a price of $21.00-$30.00. The requesting device may present the options ordered or ranked based upon a ride preference in the requesting device such as lowest cost.

As another illustrative and non-limiting example, the requesting device may determine a first ride sharing option that uses one extra-large vehicle for a price of $9.00-$12.00. The requesting device may determine a second ride sharing option that uses two large vehicles for a price of $14.00-$18.00. The requesting device again may present the options ordered or ranked based upon lowest cost as specified by the ride preferences within the requesting device.

In block 320, the requesting device is capable of presenting the ride sharing options. The requesting device, for example, is capable of displaying the ride sharing options using a user interface on a display of the requesting device or audibly presenting the ride sharing options (e.g., using text-to-speech technology or another voice/audio technology). In one or more embodiments, the requesting device is capable of prioritizing or ranking the ride sharing options based upon the ride sharing preferences of the user of the requesting device.

In block 325, the requesting device is capable of receiving a user input for the ride sharing option(s) presented in block 320. The user input, for example, may specify a selection of a particular ride sharing option or dismiss the ride sharing options. In block 330, the requesting device determines whether a ride sharing option has been selected. In response to receiving a user input selecting a ride sharing option, method 300 continues to block 335. In response to determining that the user has not selected a ride sharing option, e.g., where the user has dismissed the ride sharing options or canceled out of the process, method 300 can end.

In block 335, the requesting device requests the selected ride sharing option. For example, in response to a user selection of a ride sharing option, the requesting device is capable of notifying the ride sharing service of the particular ride sharing option selected by the user. For each vehicle used by the selected ride sharing option, for example, the requesting device is capable of notifying the driver device corresponding to that vehicle of the ride.

In block 340, the requesting device provides instructions to the vehicle(s) of the selected ride sharing option. For example, for each vehicle of the ride sharing option, the requesting device is capable of sending instruction to the driver's device associated with that vehicle. In one example, the instructions sent to each vehicle specify the pickup location for the group and the destination (e.g., common destination) for the group.

In another example, the instructions sent to each vehicle of the selected ride sharing option specify the pickup location. In addition, the instructions provided to one of the vehicles (e.g., a first vehicle) may specify a destination for the group, while the instructions provided to each other vehicle for the ride may be to follow the first vehicle to the destination. In one or more embodiments, other vehicles may be provided with instructions to follow the first vehicle only in situations where the requesting device detects that the vehicles arrive at the pickup location at approximately the same time.

In block 345, the requesting device provides payment to the drivers of the vehicles of the selected ride sharing option based upon the selected ride sharing option and/or ride preferences. Payment for the selected ride sharing option may be handled from the requesting device. The ride preferences stored within the requesting device, for example, may specify how to handle payment for group rides, which may involve more than one vehicle.

In one example, the ride preferences within the requesting device indicate that a single specified account is to be used to pay for each vehicle used for the selected ride sharing option. The single account may be the account of the user of the requesting device. In another example, the account may be an account of another entity that the user of the requesting device has permission to use. In still another example, the ride preferences may specify two or more different accounts that may be used to pay for the vehicles of the selected ride sharing option. For example, the selected accounts may be the accounts of one or more other passengers of the group. Further, the percentage of cost allocated to each account may be specified in the ride preferences thereby allowing the payment to be spread across multiple accounts in predetermined percentages.

As an illustrative and non-limiting example, users A, B, C, D, E, and F are colleagues going to a team lunch together, e.g., as a group. Using conventional ride sharing applications and/or services, the group would naturally split up with users A, B, and C taking one ride share initiated from user A's device (where user A pays for that ride share) and users D, E, and F taking a second and different ride share initiated from user D's device (where user D pays for that ride share). In this example, user D is the manager of the group and expenses the lunch and the ride. In this example, in a conventional system, user D must also seek reimbursement for expenses incurred by user A in requesting the first vehicle.

In accordance with the inventive arrangements described within this disclosure, user D, being the group manager, is capable of requesting the ride, which may involve more than one vehicle, and providing payment from a single account. For example, in response to user D launching the ride sharing application on the requesting device, the requesting device (e.g., the device of user D) is capable of detecting the mobile phone of users A, B, C, E, and F thereby estimating that the group for which a ride is needed includes six passengers.

The requesting device is capable of using stored ride preferences and current pricing for the ride sharing service and suggest that instead of using two vehicles, another cheaper ride sharing option would be to use a single extra-large vehicle. The requesting device, for example, may determine that the single extra-large vehicle is cheaper even when taking into account price surge.

In a further example, for purposes of illustration, another member of the group, e.g., user G, unexpectedly shows up at the group meeting place to go to the team lunch with the group. In this example, the requesting device is capable of detecting the additional device of user G and update the estimate of the number of passengers to seven. With the number of passengers changed from six to seven, the requesting device again determines available ride sharing options and determines that the cheapest ride sharing option is no longer getting a single extra-large vehicle, but rather getting two large size vehicles. In this example, if the ride sharing option for using two large size vehicles is selected, the driver of each of the two large size vehicles may be paid from user D's account. Further, the requesting device may provide instructions to the device of the driver of each respective vehicle.

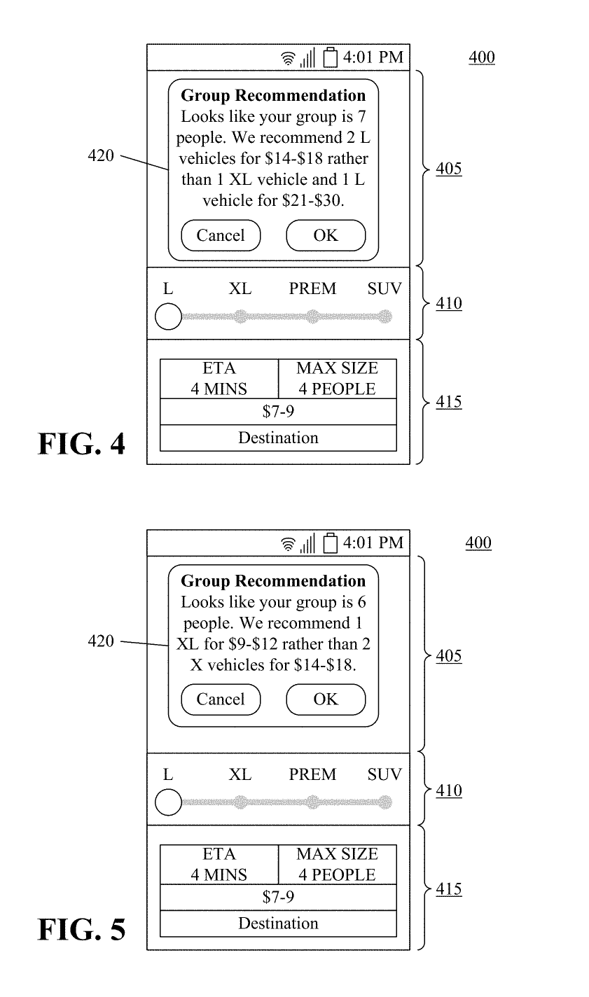

FIG. 4 depicts an example user interface 400 for use with one or more embodiments described within this disclosure. In the example of FIG. 4, user interface 400 includes region 405, region 410, and region 415. Region 405 is capable of displaying a map that illustrates the location of the requesting device and vehicles of the ride sharing service that are nearby and/or in the area of the requesting device. Region 410 includes a control that allows the user to select a vehicle size such as large (L), extra-large (XL), premium (PREM), or sport utility vehicle (SUV). In particular embodiments, region 410 may be used in cases where a user wishes to manually specify the vehicle type for a ride. Region 415 provides information relating to the particular vehicle option selected in region 410.

In the example of FIG. 4, the requesting device provides notification 420. Notification 420 indicates that the requesting device has estimated that there are seven passengers in the group. Further, the requesting device has determined that taking two large vehicles for the ride will cost less than taking one extra-large vehicle and one large vehicle.

FIG. 5 depicts another example of user interface 400 for use with one or more embodiments described within this disclosure. In the example of FIG. 5, the requesting device provides notification 520. Notification 520 indicates that the requesting device has estimated that there are six passengers in the group. Further, the requesting device has determined that taking one extra-large vehicle for the ride will cost less than taking two large vehicles.

In accordance with the inventive arrangements described herein, a device (e.g., device 105) is capable of requesting a car or ride sharing service for a group based on group data. The group data may include the number of passengers and/or ride preferences from one or more or all of the passengers in the group. For example, the device is capable of identifying potential passengers of the group by polling nearby electronic devices of the potential passengers using any of a variety of proximity technologies as described herein. The device is capable of generating a list of the potential passengers including ride preferences corresponding to individual passengers on the list. The ride preferences may include, but are not limited to, price, arrival time, and vehicle type. The device is further capable of determining ride sharing options for the group based on the list of potential passengers, the ride sharing preferences, and available ride sharing vehicles. Responsive to a selection of a ride sharing option, the device is capable of requesting the selected ride sharing option.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the singular forms “a,” “an,” and “the” are intended to include the plural forms as well, unless the context clearly indicates otherwise. As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
estimating, using a processor of a requesting device, a number of a plurality of passengers to share a ride from a ride sharing service by detecting proximate devices;
determining, using the processor, ride preferences for at least one of the plurality of passengers;
determining, using the processor, a ride sharing option from the ride sharing service for the ride based upon the number of the plurality of passengers and the ride preferences; and
requesting, using the processor, the ride sharing option.

2. The method of claim 1, further comprising:
providing payment for the ride sharing option from a selected ride sharing account.

3. The method of claim 1, wherein the ride sharing option includes a plurality of vehicles to transport the plurality of passengers for the ride, the method further comprising:
requesting each of the plurality of vehicles for the ride from the requesting device.

4. The method of claim 3, the method further comprising:
providing payment for each of the plurality of vehicles from a single ride sharing account.

5. The method of claim 3, further comprising:
providing, from the requesting device, instructions for the ride to each of the plurality of vehicles.

6. The method of claim 3, the method further comprising:
providing payment for the plurality of vehicles from at least two selected ride sharing accounts corresponding to the plurality of passengers.

7. The method of claim 1, wherein the ride preferences specify at least one of a number of passengers to be included in a same vehicle or a number of additional passengers accompanying the at least one of the plurality of passengers.

8. The method of claim 1, further comprising:
in response to detecting a scheduled event that conflicts with the ride from calendar information corresponding to a selected proximate device, excluding the selected proximate device from being used in the estimating of the number of the plurality of passengers.

9. A system, comprising:
a memory configured to store program code; and
a processor coupled to the memory, wherein the processor, in response to executing the program code, is configured to initiate operations including:
estimating a number of a plurality of passengers to share a ride from a ride sharing service by detecting proximate devices;
determining ride preferences for at least one of the plurality of passengers;
determining a ride sharing option from the ride sharing service for the ride based upon the number of the plurality of passengers and the ride preferences; and
requesting the ride sharing option.

10. The system of claim 9, wherein the processor is configured to initiate operations further comprising:
providing payment for the ride sharing option from a selected ride sharing account.

11. The system of claim 9, wherein the ride sharing option includes a plurality of vehicles to transport the plurality of passengers for the ride, wherein the processor is configured to initiate operations further comprising:
requesting each of the plurality of vehicles for the ride.

12. The system of claim 11, wherein the processor is configured to initiate operations further comprising:
providing payment for each of the plurality of vehicles from a single ride sharing account.

13. The system of claim 11, wherein the processor is configured to initiate operations further comprising:
providing instructions for the ride to each of the plurality of vehicles.

14. The system of claim 11, wherein the processor is configured to initiate operations further comprising:
providing payment for the plurality of vehicles from at least two selected ride sharing accounts corresponding to the plurality of passengers.

15. The system of claim 9, wherein the ride preferences specify at least one of a number of passengers to be included in a same vehicle or a number of additional passengers accompanying the at least one of the plurality of passengers.

16. The system of claim 9, wherein the processor is configured to initiate operations further comprising:
in response to detecting a scheduled event that conflicts with the ride from calendar information corresponding to a selected proximate device, excluding the selected proximate device from being used in the estimating of the number of the plurality of passengers.

17. A computer program product comprising a computer readable storage medium having program instructions embodied therewith, the program instructions executable by a processor of a requesting device to cause the processor to initiate operations comprising:
estimating, using a processor of a requesting device, a number of a plurality of passengers to share a ride from a ride sharing service by detecting proximate devices;
determining, using the processor, ride preferences for at least one of the plurality of passengers;
determining, using the processor, a ride sharing option from the ride sharing service for the ride based upon the number of the plurality of passengers and the ride preferences; and
requesting, using the processor, the ride sharing option.

18. The computer program product of claim 17, wherein the program instructions are executable by the processor to cause the processor to initiate operations comprising:
providing payment for the ride sharing option from a selected ride sharing account.

19. The computer program product of claim 17, wherein the ride sharing option includes a plurality of vehicles to transport the plurality of passengers for the ride, wherein the program instructions are executable by the processor to cause the processor to initiate operations comprising:
requesting each of the plurality of vehicles for the ride from the requesting device; and
providing, from the requesting device, instructions for the ride to each of the plurality of vehicles.

20. The computer program product of claim 19, wherein the program instructions are executable by the processor to cause the processor to initiate operations comprising:
providing payment for each of the plurality of vehicles from a single ride sharing account.
